(19) United States
(12) Patent Application Publication
(10) Pub. No.: US 2018/0308389 A1
(43) Pub. Date: Oct. 25, 2018

(54) COGNITIVE HEALTH AND NUTRITION ADVISOR

(71) Applicant: International Business Machines Corporation, Armonk, NY (US)

(72) Inventors: Kyle R. Moser, Stone Ridge, NY (US); Mark D. Smith, Golden, CO (US); Andrew P. Wack, Millbrook, NY (US); Maria R. Ward, Pflugerville, TX (US)

(21) Appl. No.: 15/493,179

(22) Filed: Apr. 21, 2017

(51) Int. Cl. G09B 19/00; A63B 24/00

(52) U.S. Cl. CPC G09B 19/0092; A63B 2225/50; A63B 24/0075; A63B 2024/0009; A63B 2230/30; A63B 2230/06; A63B 2230/75; A63B 2220/17; A63B 2220/20; A63B 2220/30; A63B 2230/436; A63B 2230/202; A63B 2230/20; A63B 2230/65; A63B 2230/50; A63B 24/0006

(57) ABSTRACT

Embodiments describing an approach to creating, a user profile and linking, a mobile device to one or more mobile fitness devices. Continuously collecting, user fitness data from the one of more mobile fitness devices, and continuously collecting user data. Analyzing, the user fitness data and the user data, and Responsive to the user fitness data and user data analysis, generating a personalized nutrition plan based on the optimum parameters.

### BACKGROUND OF THE INVENTION

The present invention relates generally to the field of cognitive health solutions, and more particularly to cognitive health and nutrition advisor.

In today's society, health and fitness have become a focus for a majority of individuals. There has been a steady rise of users relying more on wearable fitness devices and mobile device applications to help them achieve their fitness and health goals. However, these programs are not tailored to a particular user's need and do not provide any feedback or modification to produce desirable results. These wearable fitness devices and mobile device applications provide general information to a wide range of consumers, resulting in a wide range of efficiency and user success. As medicine and science continue to grow, many experts are realizing the one size fits all method isn't very effective and are adopting a personalized/tailored medicine approach. Over recent years, there has been an increasing trend in personalized nutrition and fitness. However, not everyone can afford a personal trainer and/or nutritionist. There is a need to take the general information given from wearable fitness devices and mobile device applications and transform the general user information into a personalized health and nutrition advisor.

### SUMMARY

According to one embodiment of the present invention, a method, computer program product, and computer system for a cognitive health advisor. A computer implemented method includes creating, by one or more processors, a user profile. linking, by the one or more processors, a mobile device to one or more mobile fitness devices. Continuously collecting, by the one or more processors, user fitness data from the one of more mobile fitness devices, and continuously collecting, by the one or more processors, user data. Analyzing, by the one or more processors, the user fitness data and the user data, wherein the analysis comprises: comparing, by the one or more processors, historical user data and historical user fitness data with the user data, the user fitness data and one or more predetermined user fitness goals to predict parameters associated with a personalized nutrition plan, creating, by the one or more processors, optimum parameters based on patterning a plurality of users matching the user profile within a predefined threshold, and continuously adjusting, by the one or more processors, the one or more user fitness goals to assist the user in reaching the one or more user fitness goals based on the analysis of the user data and the user fitness data. Responsive to the user fitness data analysis, generating, by the one or more processors, a personalized nutrition plan based on the optimum parameters.

### BRIEF DESCRIPTION OF THE DRAWINGS

FIG. 1 is a functional block diagram illustrating a distributed data processing environment, in accordance with an embodiment of the present invention;

FIG. 2 illustrates operational steps of a cognitive health advisor component, on a client device within the distributed data processing environment of FIG. 1, in accordance with an embodiment of the present invention; and

FIG. 3 depicts a block diagram of components of the server computer executing the intelligent mapping program within the distributed data processing environment of FIG. 1, in accordance with an embodiment of the present invention.

### DETAILED DESCRIPTION

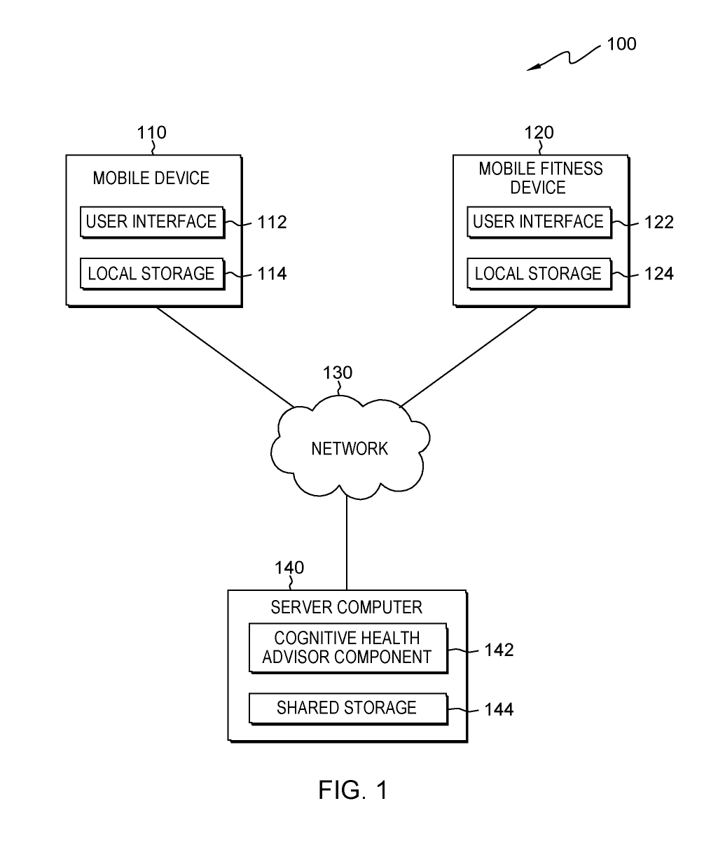

Mobile devices and mobile device applications have become a crucial part of everyday life and in some cases are necessary for everyday life. Mobile devices and/or mobile device applications are designed to make everyday life simpler and “smarter;” however, these mobile devices and/or mobile device applications have started to become overbearing and flooding users with general information. In attempts to reach and include as many consumers as possible many mobile devices, mobile fitness devices, and/or mobile device applications possess a “one size fits all model” and produce and/or run off of general information designed for mass consumption. This is especially true for wearable fitness devices and/or mobile device fitness applications. Many wearable fitness devices (i.e., mobile fitness devices) and/or mobile device applications, as shown in FIG. 1, do not offer personalized feedback and/or training, nor do they work in tandem with other wearable fitness devices and/or mobile device fitness applications. However, embodiments of the present invention, improve personal fitness and/or personal nutrition by syncing wearable fitness devices (i.e., mobile fitness device 120) and/or mobile device fitness applications. Embodiments of the present invention, further improve personalized at home fitness and/or nutrition by interlinking/connecting wearable fitness devices and mobile device applications to produce a cognitive health and nutrition advisor that can create personalized nutrition and fitness plans for users. For example, mobile fitness device 120 and/or mobile device application can sync to mobile device 110 and constantly update cognitive health advisor component 140 with the user's health statistics, exercise activity, caloric intake, diet, and/or work-out plan progress, in which cognitive health advisor component 140 tailors the exercise plan and/or nutrient plan to the user's need based on the data gathered from syncing mobile fitness device 120 and/or mobile device application to mobile device 110.

Furthermore, embodiments of the present invention, are constantly interacting, learning from each other, and/or adapting and/or updating to data. For example, a user has set a target weight goal in a mobile device application. The user can link wearable fitness devices that can monitor a user's activity, calories burned, heart rate, steps taken, miles walked and/or ran, etc., to mobile device applications such as, an online food diary, a mobile device application that can counter calories, a digital food and/or nutrition plan, a user profile, etc. Embodiments of the present invention, can take the data being produced by the wearable fitness devices and use this data to change a user's fitness and/or nutrition plan in order for the user to meet their set goal. For example, if a user doesn't meet their target weight goal, embodiments of the present invention would adjust the user's fitness plan and adapt the user's nutrition plan based on the data produced by the wearable fitness devices and the mobile device applications in order for the user to meet their target weight goal. Furthermore, the present invention improves at least one general function of computing systems. One such example of an improvement to the functioning of a computing system includes a reduction in the overall computational overhead of fitness and/or nutritional data. In this particular improvement, the computing system combines and/or converts general fitness and/or nutritional data to produce a personalized fitness and/or nutrition plan for an individual, which ultimately reduces the computational overhead needed to store and/or translate general user fitness and/or nutritional data.

Implementation of embodiments of the invention may take a variety of forms, and exemplary implementation details are discussed subsequently with reference to the Figures.

The use of the term “adjust” and/or any form and/or tense of the term “adjust” used herein, can be substituted with the term “update” and/or any variation of the term “update” known in the art. Furthermore, the term “adjust” and “adapt” can be used interchangeably and possess the same meaning.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It can be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It can also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations can be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

FIG. 1 is a functional block diagram illustrating a distributed data processing environment, generally designated 100, in accordance with one embodiment of the present invention. The term “distributed” as used in this specification describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes mobile device 110, server computer 140, mobile fitness device 120, and network 130.

Distributed data processing environment 100 includes mobile device 110, mobile fitness device 120, and server computer 140 interconnected over network 130. Network 130 can be, for example, a telecommunications network, a local area network (LAN), a wide area network (WAN), such as the Internet, or a combination of the three, and can include wired, wireless, or fiber optic connections. Network 130 can include one or more wired and/or wireless networks that are capable of receiving and transmitting data, voice, and/or video signals, including multimedia signals that include voice, data, and video information. In general, network 130 can be any combination of connections and protocols that will support communications between mobile device 110, mobile fitness device 120 and/or server computer 140.

In various embodiments, mobile device 110 can be, but is not limited to, a wearable fitness device, a standalone device, a server, a laptop computer, a tablet computer, a netbook computer, a personal computer (PC), a smart phone, a desktop computer, a smart television, a smart watch, or any combination thereof. In general, mobile device 110 can be representative of any programmable mobile device and/or a combination of programmable mobile devices capable of executing machine-readable program instructions and communicating with users of other mobile devices via network 130 and/or capable of executing machine-readable program instructions and communicating with server computer 120. In various embodiments, mobile device 110 can host a plurality mobile device applications, in which the mobile device application(s) can transform mobile device 110 into a mobile fitness device 120 when the mobile device application(s) is activated. In some embodiments, mobile device applications can collect and log user data and/or user fitness data.

In various embodiments, mobile fitness device 120 can be, but is not limited to, a wearable fitness device, a standalone device, a server, a laptop computer, a tablet computer, a netbook computer, a personal computer (PC), a smart phone, a desktop computer, a smart television, a smart watch, or any combination thereof. In general, mobile fitness device 120 can be representative of any programmable mobile device and/or a combination of programmable mobile devices capable of executing machine-readable program instructions and communicating with users of other mobile devices via network 130 and/or capable of executing machine-readable program instructions and communicating with server computer 140. Additionally, mobile fitness device 120 can be, but is not limited to, any wearable device that can measure, log, detect, record, and/or aggregate/collect a user fitness data. User fitness data can be, but is not limited to, blood pressure, heart rate, calories burned and/or calories consumed, steps taken, miles walked, steps ran/jogged, distance ran, steps taken, oxygen levels, glucose level, blood pH level, salinity of user perspiration, and/or body temperature.

In various embodiments, mobile device applications can be on mobile fitness device 120 and/or mobile device 110. In some embodiments, mobile device applications can collect and/or transmit user data and/or user fitness data from mobile fitness device 120 to mobile device 110 and vice versa. In various embodiments, mobile device applications can transform mobile device 110 into mobile fitness device 120 when activated. For example, a user can download a mobile device application for running on mobile device 110, in which this particular mobile device application measures the user's speed, average speed, distance ran, the user's route, the user's time running, and calories burned. In this particular example, once the mobile device application for running is downloaded and activated on the user device 110 can now measure the measures the user's speed, average speed, distance ran, the user's route, the user's time running, and calories burned, in which cognitive health advisor component 142 can retrieve and aggregate/collect for analysis. In some embodiments, mobile device applications can be cloud based, in which cognitive health advisor component 142 can retrieve and/or receive user data and/or fitness data. For example, a mobile device application for food journaling, a calorie counter, a mobile, a digital diet plan and/or nutrition tracker

Local storage 114, local storage 124, and shared storage 144 can be a data repository and/or a database that may be written to and read by one or a combination of cognitive health advisor component 142, user interface 112, user interface 122, server computer 140, and or all components and applications of mobile device 110, mobile fitness device 120, and/or server computer 140 known in the art. Local storage 114, local storage 124, and/or shared storage 144 can be connected via network 130 or connected through a cable and or wired connection. Local storage 114, local storage 124 and Shared storage 144 can be hard drives, memory cards, computer output to laser disc (cold storage), and or any form of data storage known in the art. In one embodiment, not illustrated in FIG. 1, local storage 114 and/or local storage 124 can be within server computer 140 and accessed via network 130.

In one embodiment, cognitive health advisor component 142 can automatically access local storage 114, local storage 124 and/or shared storage 144, via network 130 to begin analyzing data. In various embodiments, cognitive health advisor component 142 can access local storage 114, local storage 124 and/or shared storage 144 in order to create a personalized fitness and/or nutrition plan based on user fitness data and/or user profile data (i.e., user data) stored in local storage 114, local storage 124 and/or shared storage 144. In various embodiments, local storage 114, local storage 124 and/or shared storage 144 can be cloud based databases and/or service providers. In other embodiments, local storage 114, local storage 124 and/or shared storage 144 can store user fitness data from mobile device applications. In various embodiments, local storage 114, local storage 124 and/or shared storage 144 can be general and/or public data (e.g., a website, a blog, an online journal and/or diary, etc.). In various embodiments, shared storage 144 can be a knowledge repository, in which data of preexisting user data, fitness goals, nutrition goals, medical records, physical therapy techniques, physical therapy rehabilitation plans, fitness plans, nutrition plans and/or any other form of fitness and nutrition information can be stored and used by cognitive health advisor component 142 to analyze and/or to create/generate and/or adjust user fitness and/or nutrition plans. In various embodiments, cognitive health advisor component 142 can identify patterns between historic user data and/or fitness and/or nutrition goals stored on local storage 114, local storage 124, and shared storage 144 and current user data and/or fitness and/or nutrition goals. Generally, cognitive health advisor component 142 can recognized patterns between data stored in the data repository and current users who share similar traits and use the recognized patterns influence and/or improve the generated personalized nutrition and/or fitness plan.

In various embodiments, cognitive health advisor component 142 can store user data and/or user fitness data on local storage 114, local storage 124 and/or shared storage 144. In various embodiments, cognitive health advisor component 142 can retrieve user data and/or user fitness data from local storage 114, local storage 124 and/or shared storage 144. In some embodiments, the user data and/or user fitness data stored on local storage 114, local storage 124 and/or shared storage 144 can become historic user data and/or user fitness data. In various embodiments, mobile fitness device can store and/or retrieve user data and/or user fitness data from local storage 114, local storage 124 and/or shared storage 144. In various embodiments, mobile device 110 can store and/or retrieve user data and/or user fitness data from local storage 114, local storage 124 and/or shared storage 144. In various embodiments, server computer 140 can store and/or retrieve user data and/or user fitness data from local storage 114, local storage 124 and/or shared storage 144. In various embodiments, mobile device 110, mobile fitness device 122, server computer 140 can store and/or retrieve any form of data from local storage 114, local storage 124 and/or shared storage 144. User interface (UI) 112 and user interface (UI) 122 can be found on a mobile device. In exemplary embodiments user interface (UI) 112 can be found on mobile device 110 and user interface (UI) 122 can be found on mobile fitness device 120, in which UI 112 and UI 122 execute locally on mobile device 110 and/or mobile fitness device 120. UI 112 and UI 122 can operate to provide a UI to a user of mobile device 110. UI 112 and UI 122 further operate to receive user input from a user via the provided user interface, thereby enabling the user to interact with mobile device 110 and/or mobile fitness device 120.

In one embodiment, UI 112 and/or UI 122 can provide a user interface that enables a user of mobile device 110 and/or mobile fitness device 120 to interact with cognitive health advisor component 142. In various embodiments, a user can edit cognitive health advisor component 142 program settings, such as, designate language and/or user settings, via a mobile device application, website, integrated mobile settings, remote server, and any combination thereof. Program settings comprise, but are not limited to, setting fitness goals, creating and/or editing a fitness timeline, setting notifications and/or reminders, logging food consumption (e.g., food diary), creating and/or editing a nutrition plan, creating and/or updating calendars, linking and/or managing mobile device applications, and/or any other setting related features known in the art. For example, a user can sync and/or pair a plurality mobile device applications to cognitive health advisor component 142, edit cognitive health advisor component 142 settings, interact with cognitive health advisor component 142 and/or the mobile device applications, via UI 112 and/or UI 122. In various embodiments, UI 112 and/or UI 122 can be the user interface to a mobile device application. In other various embodiments, UI 112 and/or UI 122 can act as a display screen and/or monitor. In other embodiments, UI 112 and/or UI 122 can project, display, and/or receive sound, images, videos, documents, data, graphs, and/or any other form of communication data known in the art. In various embodiments, UI 112 and/or UI 122 can display a user's nutrition and/or fitness plan.

Server computer 140 may be a desktop computer, a laptop computer, a tablet computer, a specialized computer server, a smartphone, server computer or any other computer system known in the art. In certain embodiments, server computer 140 represents a computer system utilizing a cluster computers and components that act as a single pool of seamless resources when accessed through network 130, as is common in data centers and with cloud computing applications. In general, server computer 140 is representative of any programmable mobile device or combination of programmable client devices capable of executing machine-readable program instructions and communicating with other computer devices via a network (i.e., network 130).

In various embodiments, cognitive health advisor component 142 is housed on server computer 140; however, in other embodiments not depicted in FIG. 1, cognitive health advisor component 142 can be housed on, but not limited to, mobile device 110, mobile fitness device 120, a third party server computer, and/or out a mobile device and/or sever computer outside of computing environment 100. In various embodiments, cognitive health advisor component 142 can create custom fitness and/or nutrition plans and/or programs for users based on the user profile and/or data produced from mobile fitness device 120 to help the user meet their health and/or fitness goals. For example, if a user sets a fitness goal to lose 10 pounds (lbs) then cognitive health advisor component 142 can continuously monitor the user's data from mobile fitness device 120 and analyze the user fitness data from mobile fitness device 120 against the user profile and adjust the user nutrition plan and/or fitness plan to assist the user in their weight loss goal. In other embodiments, cognitive health advisor component 142 can continuously monitor, analyze, and/or aggregate/collect a plurality of mobile fitness devices 120 and/or a plurality of user fitness data. In various embodiments, cognitive health advisor component 142 can adjust the severity of the nutrition and/or fitness plan based on the user's fitness/health goal and the user fitness data reported from the mobile fitness device 120. For example, if the user wants to loss 5 lbs in two weeks, cognitive health advisor component 142 can implement a strict nutrition plan and/or intense fitness plan (i.e., workout regimen). In various embodiments, cognitive health advisor component 142 can sync with a plurality of mobile fitness device 120 and/or mobile device applications.

Mobile device applications can be, but are not limited to, applications on mobile device 110 that can be installed via a computer and/or download via website and/or a cloud service, in which the mobile device application tracks fitness activity, caloric intake, documents food consumed (i.e., a food diary), heart rate, blood pressure, and/or any other fitness and/or nutrition related data known in the art. In other embodiments, mobile device applications can link mobile device 110 and mobile fitness device 120, via network 130, in which mobile fitness device 120 settings and/or user fitness data can be accessible, managed, and/or displayed on mobile device 110. In various embodiments, mobile device applications can connect mobile device 110, mobile fitness device 120, and/or server computer 140, via network 130, in which cognitive health advisor component 142 and/or mobile fitness device 120 settings and/or user fitness data can be accessible, managed, and/or displayed on mobile device 110.

In other embodiments, cognitive health advisor component 142 can adjust and/or update nutrition plans based on allergies and/or the user's physical reaction to certain food items. In other embodiments, cognitive health advisor component 142, can learn the user's preference in food and adjust and/or develop nutrition plans implementing the user's preferred food preferences. For example, if a user prefers blueberries over strawberries then cognitive health advisor component 142 can develop a nutrition plans implementing blueberries instead of strawberries. In various embodiments, cognitive health advisor component 142 learns user preferences through a user ranking system. For example, after a nutrition plan is complete cognitive health advisor component 142 can ask a user for feedback, rating and/or a ranking on the completed nutrition plan. In various embodiments, cognitive health advisor component 142 can ask the user to rank the dishes and/or meals, describe and/or list their favorite meal and/or least favorite meal, etc. In other embodiments, cognitive health advisor component 142 can ask a user to rank and/or rate a meal and/or particular dish. In various embodiments, cognitive health advisor component 142 can be integrated with and/or enlist the help from a super computer, artificial intelligence (AI), cognitive computing, and/or other complicated algorithms to assist with user data and/or user fitness data analysis. In various embodiments, cognitive health advisor component 142 can continuously use cognitive learning, via cognitive computing, to adjust, update, and/or personalize a user's fitness plan and/or nutrition plan. In various embodiments, user fitness data can be entered manually. For example, a user takes off mobile fitness device 120 and goes for a 30-minute swim, and upon completion of their fitness activity manually enters their fitness data (e.g., 0.8 miles in 30-minutes), and the exertion is calculated, via cognitive health advisor component 142. In other embodiments, user fitness data can be collected and/or recorded automatically by mobile fitness device 120, mobile device application, and/or cognitive health advisor component 142.

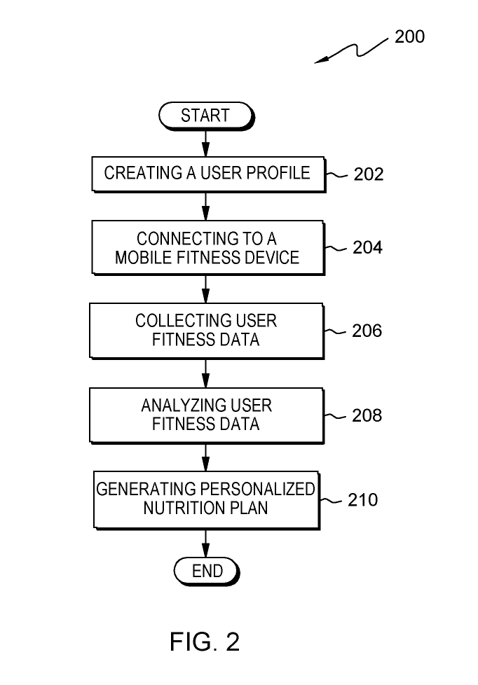

In various embodiments, cognitive health advisor component 142 can learn a user's food preferences from the user's data on the user's profile and/or user settings. A user profile can comprise, user data, in which user data can be, but is not limited to, fitness goals, activity levels (e.g., how physically active a user is), height, weight, age, gender, body mass index (BMI), medical history, known allergies, food preferences (i.e., meal ranking and/or ratings), dietary restrictions, cooking skill level, available time to cook, available energy resources to cook, available energy resources to cook, available food types/ingredients, macronutrients, micronutrients, cultural background, religious consideration, medical history, family medical history (e.g., heart disease, diabetes), alcohol consumption, tobacco consumption, socioeconomic status, occupation, and/or any relevant health and/or medical data known in the art. In various embodiments, a user can create a new user profile and/or cognitive health advisor component 142 can retrieve a preexisting user profile. In various embodiments, cognitive health advisor component 142 can possess user settings. Continuing to illustrate the aforementioned embodiment, the user settings enable a user to modify and/or update cognitive health advisor component 142 with fitness goals, fitness timelines, and/or any other user data. In various embodiments, cognitive health advisor component 142 can continuously monitor, analyze, and/or aggregate/collect user data and/or user fitness data to generate a personalized fitness program and/or nutrition plan, in which cognitive health advisor component 142 continuously updates the generated personalized fitness program and/or nutrition plan based on the aggregated/collected and/or analyzed user data and/or user fitness data. Cognitive health advisor component 142 is depicted and described in further detail with respect to FIG. 2.

FIG. 2 is a flowchart depiction operational steps of cognitive health advisor component 142, generally designated 200, on server computer 140 within distributed data processing environment 100 of FIG. 1, cognitive health advisor, in accordance with an embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

In step 202, cognitive health advisor component 142 creates a user profile. In various embodiments, a user can create a user profile if the user has not previously created a profile and/or cognitive health advisor component 142 cannot locate and/or retrieve a previously created user profile stored on shared storage 144, local storage 114, and/or local storage 124. In various embodiments, cognitive health advisor component 142 receives a user profile from shared storage 144, local storage 114, and/or local storage 124. The user profile comprises user data, in which user data comprises, but is not limited to, fitness goals, activity levels (e.g., how physically active a user is), height, weight, age, gender, body mass index (BMI) medical history, known allergies, food preferences, dietary restrictions, cooking skill level, available time to cook, available energy resources to cook, available energy resources to cook, available food types/ingredients, macronutrients, micronutrients, cultural background, religious consideration, medical history, family medical history (e.g., heart disease, diabetes), alcohol consumption, tobacco consumption, socioeconomic status, occupation, and/or any relevant health and/or medical data known in the art. In various embodiments user data can be stored on shared storage 144, local storage 124, and/or local storage 144. In other embodiments, a user can create a user profile from information (user data) received by user input. For example, cognitive health advisor component 142 can display a questionnaire for the user to fill out, similar to a medical form seen in a doctor's office or hospital. In other embodiments, cognitive health advisor component 142 can retrieve user data from a pre-existing file containing the user's data and create a user profile.

In step 204, cognitive health advisor component 142 links to mobile fitness device 120. In various embodiments, cognitive health advisor component 142 is on mobile device 110, in which mobile device can link, connect, and/or communicate with one or more mobile fitness device 120, and/or mobile device applications. In various embodiments, cognitive health advisor component 142 can connect to mobile fitness device 120 via network 130, in which user fitness data can be consistently communicated and/or shared between mobile device 110, mobile fitness device 120, mobile device applications and/or cognitive health advisor component 142. For example, cognitive health advisor component 142 can receive and/or retrieve user fitness data from mobile fitness device 120 (e.g., miles ran, calories burned, heart rate, weight etc.), analyze the user fitness data received and send an updated fitness and/or health plan to mobile device 110.

In step 206, cognitive health advisor component 142 collects user fitness data. In various embodiments, cognitive health advisor component 142 aggregates/collects user fitness data from a plurality of mobile fitness device 120 and/or a plurality of mobile device applications. In some embodiments, mobile fitness devices 120 and/or mobile device applications can record and/or log a user's fitness level and/or fitness activity. For example, if a user goes on a run mobile fitness device 120 and/or a mobile device application record and log the user's distance ran, time it took the user to complete the run, steps taken, the route the user took, the user's average speed, calories burned, heart rate, pulse, and, blood pressure, in which cognitive health advisor component 142 aggregates/collects the recorded and/or logged data from mobile fitness device 120 and/or the mobile device application for analysis. In various embodiments, cognitive health advisor component 142 continuously aggregates/collects user fitness data for analysis, in which cognitive health advisor component 142 continuously updates the generated personalized fitness and/or nutrition plan.

In step 208, cognitive health advisor component 142 analyzes user fitness data from mobile fitness device 120. In other embodiments, cognitive health advisor component 142 analyzes user fitness data and user data. In various embodiments, cognitive health advisor component 142 can continuously collect and/or analyze the user fitness data logged and/or recorded by mobile fitness device 120 and/or mobile device applications. In various embodiments, cognitive health advisor component 142 can analyze the user data and/or the user fitness data by, comparing historical user data and historical user fitness data with the user data, the user fitness data, and/or one or more predetermined user fitness goals to predict parameters associated with a personalized nutrition plan. Continuing this particular embodiment, cognitive health advisor component 142 can create optimum parameters based on patterning a plurality of users matching the user profile within a predefined threshold, and can continuously adjust the one or more user fitness goals to assist the user in reaching the one or more user fitness goals based on the analysis of the current user data and the user fitness data, and the historic user data and/or user fitness data.

For example, a user has set a weight loss goal of 10 lbs and has set a three-month timeline/projected goal data with a bi-weekly status update determined, using the cognitive health advisor component 142 settings; however, at the first bi-weekly status update the user data reveals that the user has gained some weight. In this particular example, cognitive health advisor component 142, can analyze the user fitness data aggregated/collected and/or produced by mobile fitness device 120 and the user data to adjust the user's fitness and/or nutrition plan. In various embodiments, the user fitness data can be recorded, logged and/or aggregated/collected by mobile fitness device 120. User fitness data can be, but is not limited to, a user's: blood pressure, heart rate, pulse, calories burned and/or calories consumed, blood pressure, steps taken, miles walked, steps ran/jobbed, distance ran, glucose level, blood pH level, salinity of user perspiration, and/or body temperature. In various embodiments, cognitive health advisor component 142 can receive and/or aggregate/collect and analyze, monitor, and/or compare the user's fitness data and/or the user's profile data (i.e., user data) in order to learn a user's habits and/or adjust the user's fitness and/or health plan.

In another example, if cognitive health advisor component 142 initially had instructed the user to exercise 3 times a week using various work regimen produce by cognitive health advisor component 142 and instructed the user to consume 2000 calories a day (via provided nutrition plan), then cognitive health advisor component 142 can adjust the user fitness plan to include a more intense workout regime and increase the user's workout frequency to 4 times a week, and adjust the users nutrition plan by cutting the users daily caloric intake to 1500 (via provided recipes), in order for the user to reach their fitness goal. In various embodiments, cognitive health advisor component 142 can display the changes to the user via UI 112 and/or UI 122, in which the user can either accept or decline the adjustments made by cognitive health advisor component 142. In various embodiments, a user can set and/or determine how frequent they would like to have fitness and/or nutrition status updates, check points, and/or evaluations, in which cognitive health advisor component 142 monitor and/or evaluates the users progress. In other embodiments, cognitive health advisor component 142 determines user status checks automatically based on the user's goals. In various embodiments, cognitive health advisor component 142 can continuously aggregate/collect and/or analyze user fitness data. In some embodiments, cognitive health advisor component 142 can continuously analyze user data and/or user fitness data, and comparing analysis results with a user fitness goal in order to continuously update the generated customized/personalized nutrition and/or health plan.

In various embodiments, cognitive health advisor component 142 can compare historical user data and historical user fitness data with the present/current user data, the user fitness data and/or one or more predetermined user fitness goals to predict parameters associated with a personalized fitness and/or nutrition plan. In another embodiment, cognitive health advisor component 142 search the knowledge repository (i.e., shared storage 144) for any patterns and/or similar user data and/or fitness data, in which cognitive health advisor component 142 analyzes the historic user data and/or user profiles for former nutrition plans, user data, fitness plans, exercises, and/or case studies that were implemented in historic/past user nutrition and/or fitness plans that are associated with similar user data to the current user data. In other embodiment, cognitive health advisor component 142 can create optimum parameters based on patterning a plurality of users matching the user profile within a predefined threshold.

For example, a current user has user data and fitness data comprising a 26 years old male, who is 6 feet tall, who burns 2000 calories a day, intakes 2500 calories a day, weighing 200 lbs, who has a bad right knee, and has set a fitness goal to lose 5 lbs. In this particular example, cognitive health advisor component 142 can take the current user data and search shared storage 144 for males between the age of 24 and 28, who have similar knee injury restrictions, who weigh 180 to 220 lbs, who burns 1500 to 2500 calories a day, intakes 2000 to 3000 calories a day, who have a fitness goal to lose 5 to 10 lbs, and ranges from 5 feet 10 inches tall to 6 feet 2 inches tall, in which cognitive health advisor component 142 analyzes the similar historic user data, user profile, and/or user fitness data and implements successful portions of the historic fitness and/or nutrition plans into the generated personalized nutrition and/or fitness plan. Furthering this particular example, if cognitive health advisor component 142 recognizes in the similar historical data that users who implemented more green vegetables in their meals and cut back on meat had an increase in weightless, then cognitive health advisor component 142 will recognize this pattern/tread as optimal parameter and implement them into the personalized nutrition and/or fitness plan.

In various embodiments a user can set the predefined thresholds by increasing or decreasing the ranges of similarity (i.e., increasing and/or decreasing the data pool). For example, the user can select cognitive health advisor component 142 to locate and analyze historical data that is 90% similar to their user data and/or user fitness data. In another example, a user can set the ranges for each individual data element. Predefined threshold can be, but is not limited to, determining the range of selection for user data and/or user fitness data. Optimum parameters can be, but are limited to, nutrition and/or fitness parameters that have been successful in historic data.

In step 210, cognitive health advisor component 142 generates a personalized nutrition plan. In various embodiments, cognitive health advisor component 142 can generate a personalized/tailored fitness and/or nutrition plan for a user based on the user's profile (i.e., user data) and/or user fitness data aggregated/collected and/or produced by mobile fitness device 120. For example, if a user has a lactose allergy and suffers from chronic knee pain from a past knee injury, then cognitive health advisor component 142 can generate/create a nutrition plan excluding dishes containing lactose and a fitness plan with little to no impact to the knee. In another example, a user broke their arm and the user wants to maintain their current weight and stay active. In this particular example, the user would update cognitive health advisor component 142 of their injury, via user profile and/or cognitive health advisor component 142 settings, in which cognitive health advisor component 142 can adjust the user's fitness plan to include one arm and exercises approved by physicians for individuals with a broken arm; additionally, cognitive health advisor component 142 can adjust the users nutrition plan (perhaps lower caloric intake) in order for them to maintain their current weight.

In this particular example, cognitive health advisor component 142 can also assist with rehabilitation and adjust the user's fitness plan based on the users healing process. For example, as the user's arm strength grows cognitive health advisor component 142 increases the intensity of the arm exercise. In various embodiments, cognitive health advisor component 142 can be responsive to the analysis of a user's fitness data. In this particular embodiment, depending on the user's fitness data cognitive health advisor component 142 can adjust the nutrition and/or fitness plan to meet a user's specific needs and/or to meet their fitness and/or nutrition goal. In various embodiments, once the adjustment has been made cognitive health advisor component 142 can continue to monitor the user fitness data and continually adjust the user's fitness and/or nutrition plan, via repeating steps 206-208. In various embodiments, cognitive health advisor component 142 can be integrated with and/or enlist the help from a super computer, artificial intelligence (AI), cognitive computing, and/or other complicated algorithms to assist with user data and/or user fitness data analysis.

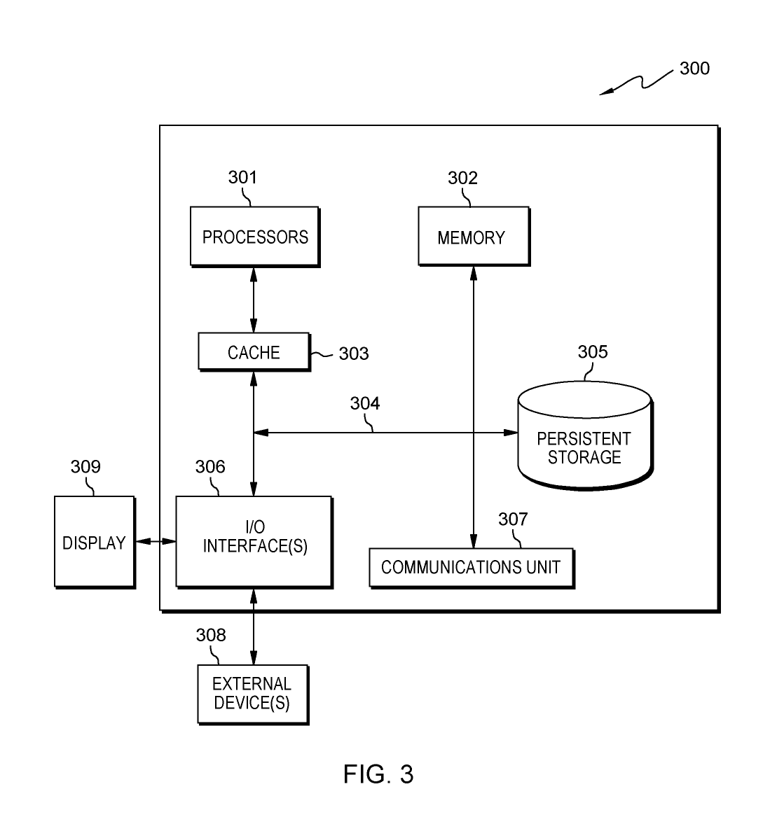

FIG. 3 depicts a block diagram of components of server computer 140 within distributed data processing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

FIG. 3 depicts a block diagram of components of a computing device within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

FIG. 3 depicts computer system 300, where server computer 140 represents an example of computer system 300 that includes cognitive health and nutrition advisor. The computer system includes processors 301, cache 303, memory 302, persistent storage 305, communications unit 307, input/output (I/O) interface(s) 306 and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processors 301 by holding recently accessed data, and data near recently accessed data, from memory 302.

Program instructions and data used to practice embodiments of the present invention may be stored in persistent storage 305 and in memory 302 for execution by one or more of the respective processors 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data used to practice embodiments of the present invention may be downloaded to persistent storage 305 through communications unit 307.

I/O interface(s) 306 enables for input and output of data with other devices that may be connected to each computer system. For example, I/O interface 306 may provide a connection to external devices 308 such as a keyboard, keypad, a touch screen, and/or some other suitable input device. External devices 308 can also include portable computer readable storage media such as, for example, thumb drives, portable optical or magnetic disks, and memory cards. Software and data used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

What is claimed is:

1. A method for creating a personalized nutrition plan, via a cognitive health advisor, the method comprising:
creating, by one or more processors, a user profile;
linking, by the one or more processors, a mobile device to one or more mobile fitness devices;
continuously collecting, by the one or more processors, user fitness data from the one of more mobile fitness devices;
continuously collecting, by the one or more processors, user data;
analyzing, by the one or more processors, the user fitness data and the user data, wherein the analysis comprises:
comparing, by the one or more processors, historical user data and historical user fitness data with the user data, the user fitness data and one or more predetermined user fitness goals to predict parameters associated with a personalized nutrition plan;
creating, by the one or more processors, optimum parameters based on patterning a plurality of users matching the user profile within a predefined threshold; and
continuously adjusting, by the one or more processors, the one or more user fitness goals to assist the user in reaching the one or more user fitness goals based on the analysis of the user data and the user fitness data; and
responsive to the user fitness data analysis, generating, by the one or more processors, a personalized nutrition plan based on the optimum parameters.

2. The method of claim 1, wherein the optimum parameters are continuously updating based on the analysis of the user data and the user fitness data.

3. The method of claim 1, wherein the adjusting to the one or more fitness plans further comprises accessing a knowledge repository to analyze pre-existing user data, fitness goals, nutrition goals, medical records, physical therapy techniques, physical therapy rehabilitation plans, fitness plans, and nutrition plans against the user data and the user fitness data.

4. The method of claim 1, wherein, wherein the nutrition plan comprises both a fitness plan and nutrition plan.

5. The method of claim 1, wherein the mobile fitness device comprises a mobile device application.

6. The method of claim 1, wherein the user data comprises fitness goals, activity levels, height, weight, age, gender, body mass index (BMI), medical history, known allergies, food preferences, dietary restrictions, cooking skill level, available time to cook, available energy resources to cook, available energy resources to cook, available food types/ingredients, macronutrients, micronutrients, cultural background, religious consideration, medical history, family medical history, alcohol consumption, tobacco consumption, socioeconomic status, occupation, or any combination therein; and
wherein the user fitness data comprises blood pressure, heart rate, calories burned and/or calories consumed, steps taken, miles walked, steps ran/jogged, distance ran, user speed and average speed, pulse, steps taken, oxygen levels, glucose level, blood pH level, salinity of user perspiration, and body temperature.

7. The method of claim 6, wherein the user fitness data can be entered manually.

8. A computer program product for creating a personalized nutrition plan, via a cognitive health advisor, the computer program product comprising:
one or more computer readable storage devices and program instructions stored on the one or more computer readable storage devices, the stored program instructions comprising:
program instructions to, create a user profile;
program instructions to, link a mobile device to one or more mobile fitness devices;
program instructions to, continuously collect user fitness data from the one of more mobile fitness devices;
program instructions to, continuously collect user data;
program instructions to, analyze the user fitness data and the user data, wherein the analysis comprises:
program instructions to, compare historical user data and historical user fitness data with the user data, the user fitness data and one or more predetermined user fitness goals to predict parameters associated with a personalized nutrition plan;
program instructions to, create optimum parameters based on patterning a plurality of users matching the user profile within a predefined threshold; and
program instructions to, continuously adjust the one or more user fitness goals to assist the user in reaching the one or more user fitness goals based on the analysis of the user data and the user fitness data; and
responsive to the user fitness data analysis, program instructions to, generate by the one or more processors, a personalized nutrition plan based on the optimum parameters.

9. The computer program product of claim 8, wherein the optimum parameters are continuously updating based on the analysis of the user data and the user fitness data.

10. The computer program product of claim 8, wherein the adjusting to the one or more fitness plans further comprises accessing a knowledge repository to analyze pre-existing user data, fitness goals, nutrition goals, medical records, physical therapy techniques, physical therapy rehabilitation plans, fitness plans, and nutrition plans against the user data and the user fitness data.

11. The computer program product of claim 8, wherein, wherein the nutrition plan comprises both a fitness plan and nutrition plan.

12. The computer program product of claim 8, wherein the mobile fitness device comprises a mobile device application.

13. The computer program product of claim 8, wherein the user data comprises fitness goals, activity levels, height, weight, age, gender, body mass index (BMI), medical history, known allergies, food preferences, dietary restrictions, cooking skill level, available time to cook, available energy resources to cook, available energy resources to cook, available food types/ingredients, macronutrients, micronutrients, cultural background, religious consideration, medical history, family medical history, alcohol consumption, tobacco consumption, socioeconomic status, occupation, or any combination therein.

14. The computer program product of claim 8, wherein the user fitness data comprises blood pressure, heart rate, calories burned and/or calories consumed, steps taken, miles walked, steps ran/jogged, distance ran, user speed and average speed, pulse, steps taken, oxygen levels, glucose level, blood pH level, salinity of user perspiration, and body temperature.

15. A computer system comprising:
one or more computer processors;
one or more computer readable storage devices;
program instructions stored on the one or more computer readable storage devices for execution by at least one of the one or more computer processors, the stored program instructions comprising:
program instructions to, create a user profile;
program instructions to, link a mobile device to one or more mobile fitness devices;
program instructions to, continuously collect user fitness data from the one of more mobile fitness devices;
program instructions to, continuously collect user data;
program instructions to, analyze the user fitness data and the user data, wherein the analysis comprises:
program instructions to, compare historical user data and historical user fitness data with the user data, the user fitness data and one or more predetermined user fitness goals to predict parameters associated with a personalized nutrition plan;
program instructions to, create optimum parameters based on patterning a plurality of users matching the user profile within a predefined threshold; and
program instructions to, continuously adjust the one or more user fitness goals to assist the user in reaching the one or more user fitness goals based on the analysis of the user data and the user fitness data; and
responsive to the user fitness data analysis, program instructions to, generate by the one or more processors, a personalized nutrition plan based on the optimum parameters.

16. The computer system of claim 15, wherein the optimum parameters are continuously updating based on the analysis of the user data and the user fitness data.

17. The computer system of claim 15, wherein the adjusting to the one or more fitness plans further comprises accessing a knowledge repository to analyze pre-existing user data, fitness goals, nutrition goals, medical records, physical therapy techniques, physical therapy rehabilitation plans, fitness plans, and nutrition plans against the user data and the user fitness data.

18. The computer system of claim 15, wherein, wherein the nutrition plan comprises both a fitness plan and nutrition plan.

19. The computer system of claim 15, wherein the mobile fitness device comprises a mobile device application.

20. The computer system of claim 15, wherein the user data comprises fitness goals, activity levels, height, weight, age, gender, body mass index (BMI), medical history, known allergies, food preferences, dietary restrictions, cooking skill level, available time to cook, available energy resources to cook, available energy resources to cook, available food types/ingredients, macronutrients, micronutrients, cultural background, religious consideration, medical history, family medical history, alcohol consumption, tobacco consumption, socioeconomic status, occupation, or any combination therein; and
wherein the user fitness data comprises blood pressure, heart rate, calories burned and/or calories consumed, steps taken, miles walked, steps ran/jogged, distance ran, user speed and average speed, pulse, steps taken, oxygen levels, glucose level, blood pH level, salinity of user perspiration, and body temperature.
